(19) United States
(12) Patent Application Publication
(10) Pub. No.: US 2001/0040976 A1
(43) Pub. Date: Nov. 15, 2001

(54) Panel-form loudspeakers with hidden exciters

(76) Inventor: Andreas Buos, Cambridgeshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/726,590

(22) Filed: Dec. 1, 2000

Related U.S. Application Data
(60) Provisional application No. 60/172,139, filed on Dec. 17, 1999.

(30) Foreign Application Priority Data
Dec. 2, 1999 (GB) 9928456.4

(51) Int. Cl. H04R 1/02; H04R 1/20

(52) U.S. Cl. 381/431; 381/89; 381/337

(57) ABSTRACT

A bending wave panel-form loudspeaker comprises a spaced pair of panels supported at their edges and defining between them a shallow sealed fluid cavity. Vibration exciters are disposed in the fluid cavity and are arranged to drive the respective panels. The electrical connections to the exciters are at least partially in antiphase such that the predominant motion of the panels is in phase to provide a degree of dipole radiation property for the loudspeaker. The gap between the panels is in the range 2 to 25 mm such that the shallow cavity provides conditions in which fluid coupling dynamics and behavior is asserted between the pair of panels due to the fluid layer between them.

This application claims the benefit of provisional application No. 60/172,139, filed Dec. 17, 1999.

### TECHNICAL FIELD

The invention relates to loudspeakers and more particularly to bending wave panel-form loudspeakers, e.g. resonant bending wave panel speakers as exemplified by the disclosure in W097/09842 of New Transducers Limited. Loudspeakers as exemplified in WO97/09842 have become known as distributed mode loudspeakers.

### BACKGROUND ART

It is known in bending wave panel-form loudspeakers to embed vibration exciting transducers in the loudspeaker panel so that the exciter is hidden and so that the surface of the panel is unobstructed. See, e.g., WO97/09859 and WO99/13684. The provision of an embedded exciter does however complicate the construction of the loudspeaker in comparison to one having an exciter mounted on the panel surface, and increases the cost of the loudspeaker.

It is known from WO99/67974 to provide a loudspeaker comprising a spaced pair of vibrating diaphragms defining a cavity between them. It is also known from WO98/16409 to provide a vehicle sun visor as a loudspeaker comprising a spaced pair of vibrating panels defining between them a cavity in which piezoelectric transducers for exciting the panels are located. Further, it is known from DE 298,11,727 U1 to provide a loudspeaker comprising a spaced pair of panels defining a cavity in which transducers for exciting the two panels are located.

### SUMMARY OF THE INVENTION

A bending wave panel-form loudspeaker according to the invention comprises a spaced pair of juxtaposed panels separated by a gap and sealingly supported at their edges to define between them a shallow sealed fluid cavity. Each of the panels is capable of sustaining and propagating input vibrational energy by bending waves. At least two vibration exciters are located in the fluid cavity for driving the panels, each exciter being coupled to a respective panel. The electrical connections to the exciters are at least partially in antiphase such that the predominant motion of the panels is in phase to provide a degree of dipole radiation property for the loudspeaker. The gap between the panels is sized such that the shallow cavity provides conditions in which fluid coupling dynamics and behaviour is asserted between the pair of panels due to the fluid layer between them.

In this way the vibration exciters can be surface mounted on the panels, but are hidden from view in the fluid gap. The vibration exciters may be electrodynamic inertial devices each being mounted wholly and exclusively on a respective panel. More than one vibration exciter may be fixed to the inside face of each panel.

The panels may be suspended at their edges by a body member that surrounds and is sealed to the panels. The body member, which may be in the form of a frame or a shim between the panels, may clamp the panel edges.

The panels may be distributed mode resonant acoustic radiators, e.g. as disclosed in WO97/09842 and counterpart U.S. application Ser. No. 08/707,012, filed Sep. 3, 1996 (the latter being incorporated herein by reference in its entirety).

From another aspect, the invention is a display board that functions as a loudspeaker as described above. The exposed surfaces of the panels are adapted to display information or artwork, e.g. text and/or graphics, so as to form a two-sided display useful for advertising or other display purposes.

### BRIEF DESCRIPTION OF THE DRAWING

An example that embodies the best mode for carrying out the invention is described in detail below and diagrammatically illustrated in the accompanying drawing, in which:

FIG. 1 is a cross-sectional side view of a resonant bending wave panel-form loudspeaker of the present invention, and

FIG. 2 is a graph of the frequency response of a typical loudspeaker, formed as shown in FIG. 1.

### DETAILED DESCRIPTION

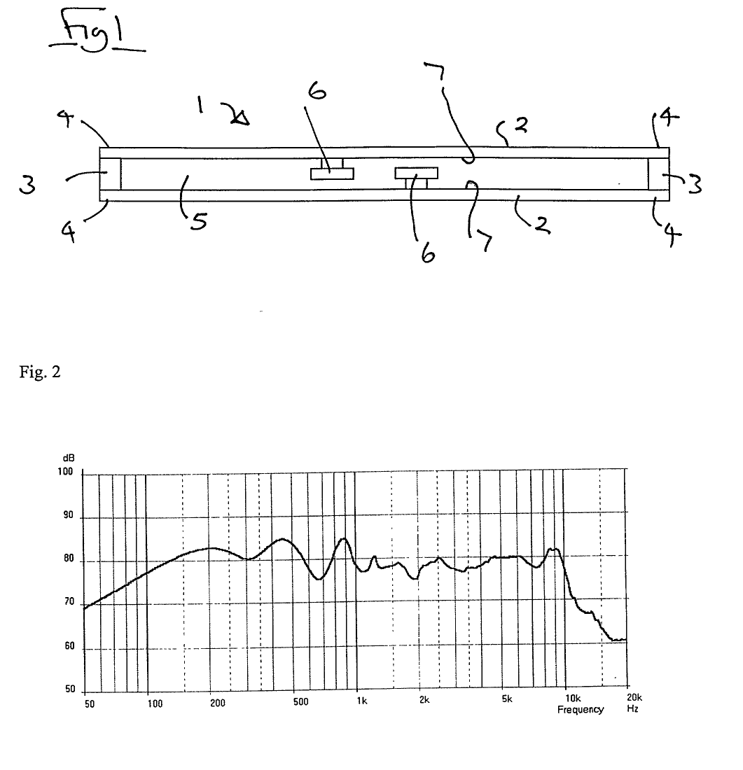

In FIG. 1 there is shown a distributed mode loudspeaker (1) comprising two resonant bending wave panels (2) clamped by their edges (4) back to back in a frame (3), and operating as a dipole sound radiator. The two panels and the frame define a sealed shallow cavity (5).

Each of the two (front and back) panels is driven by one or more electrodynamic inertial exciters (6), mounted on the inwardly facing surfaces (7) of the panels so that the exciters (6) are mounted in the cavity (5), and generating distributed mode type bending waves in each of the panels, e.g. as described in WO97/09842 and U.S. Ser. No. 08/707,012. The exciters of the front and rear panel are connected to be electrically out of phase, in order to form a mechanical dipole system, meaning that the mechanical excursion of the front and rear panel is in phase.

The two panels (12) are clamped to the frame (3) around their entire perimeters, to create a small sealed air volume that can be described as a fluid system for a stiff coupling between the front and the pack panel, preventing any unwanted front to back panel interaction caused by an otherwise possible resonance in the enclosure. The fluid coupling between the front and back panel also supports the mechanical dipole excursion due to its high mechanical spring stiffness. In the example of a small panel given below in relation to FIG. 2, the cavity depth is 6 mm.

It is envisaged that the loudspeakers of the present invention might find application in relation to inexpensive signboards and advertising displays, e.g. point of purchase, or POP, displays in stores and supermarkets. The surfaces of the loudspeakers thus would be adapted to display information or artwork of any type, such as text and/or graphics, and thereby form an advertising or display board with the additional feature of an audio output to enhance the display appeal. Often such display boards may be relatively large, e.g. around one meter square, and in such a case, the shallow cavity between the panels may be up to about 25 mm in depth.

FIG. 2 shows the frequency response curve of a panel constructed according to FIG. 1. Two identical panels (590×495×3 mm) are mounted on a rigid spacer frame of 6 mm thickness and form a completely sealed thin closed loudspeaker. Each panel is driven by two 13 mm exciters with a total nominal impedance of 2 ohms. The front and rear exciter configurations are in series connection and electrically out of phase, giving a total nominal impedance of the system of 4 ohm. The sound pressure level measurement shown in FIG. 2 is on axis at 0.5 m with 2.83 Vrms input.

The invention thus provides a useful alternative to known embedded bending wave panel-form loudspeakers. The benefit is an economical two-sided bending wave speaker system of desirable thinness which is broadly equivalent to a standard single panel speaker but where the method of excitation is wholly concealed within the speaker assembly. Thus signboards may have information on both sides of an assembly without obstruction. In addition the exciters are wholly protected from environmental and/or casual damage.

1. A bending wave panel-form loudspeaker comprising:
a spaced pair of juxtaposed panels separated by a gap and sealingly supported at their edges to define between them a shallow sealed fluid cavity, each of the panels being capable of sustaining and propagating input vibrational energy by bending waves, and
at least two vibration exciters in the fluid cavity for driving the panels, each exciter being coupled to a respective panel,
wherein the electrical connections to the exciters are at least partially in antiphase such that the predominant motion of the panels is in phase to provide a degree of dipole radiation property for the loudspeaker, and
wherein the gap between the panels is sized such that the shallow cavity provides conditions in which fluid coupling dynamics and behaviour is asserted between the pair of panels due to the fluid layer between them.

2. A loudspeaker according to claim 1, wherein the gap between the panels is in the range of about 2 mm to about 25 mm.

3. A loudspeaker according to claim 1, wherein the panels are supported at their edges by a body member that surrounds and is sealed to the panels.

4. A loudspeaker according to claim 3, wherein the body member is clamped to the panels at their edges.

5. A loudspeaker according to claim 1, wherein the panels are resonant acoustic radiators.

6. A loudspeaker according to claim 5, wherein the panels are distributed mode resonant acoustic radiators.

7. A loudspeaker according to claim 5, wherein the exciters are electrodynamic inertial devices each of which is mounted wholly and exclusively on a respective panel.

8. A loudspeaker according to claim 1, wherein the exciters are electrodynamic inertial devices each of which is mounted wholly and exclusively on a respective panel.

9. A display board and loudspeaker combination comprising:
a spaced pair of juxtaposed panels separated by a gap and sealingly supported at their edges to define between them a shallow sealed fluid cavity, each of the panels being capable of sustaining and propagating input vibrational energy by bending waves, and the exposed surfaces of the panels being adapted to display information or artwork, and
at least two vibration exciters in the fluid cavity for driving the panels, each exciter being coupled to a respective panel,
wherein the electrical connections to the exciters are at least partially in antiphase such that the predominant motion of the panels is in phase to provide a degree of dipole radiation property for the loudspeaker, and
wherein the gap between the panels is sized such that the shallow cavity provides conditions in which fluid coupling dynamics and behaviour is asserted between the pair of panels due to the fluid layer between them.

10. A loudspeaker according to claim 9, wherein the gap between the panels is in the range of about 2 mm to about 25 mm.

11. A loudspeaker according to claim 9, wherein the panels are supported at their edges by a body member that surrounds and is sealed to the panels.

12. A loudspeaker according to claim 11, wherein the body member is clamped to the panels at their edges.

13. A loudspeaker according to claim 9, wherein the panels are resonant acoustic radiators.

14. A loudspeaker according to claim 13, wherein the panels are distributed mode resonant acoustic radiators.

15. A loudspeaker according to claim 13, wherein the exciters are electrodynamic inertial devices each of which is mounted wholly and exclusively on a respective panel.

16. A loudspeaker according to claim 9, wherein the exciters are electrodynamic inertial devices each of which is mounted wholly and exclusively on a respective panel.
